(19) United States
(12) Patent Application Publication
(10) Pub. No.: US 2015/0003118 A1
(43) Pub. Date: Jan. 1, 2015

(54) START-UP CIRCUIT, SWITCH CONTROL CIRCUIT HAVING THE START-UP CIRCUIT AND POWER SUPPLY DEVICE HAVING THE SWITCH CONTROL CIRCUIT

(71) Applicant: FAIRCHILD KOREA SEMICONDUCTOR LTD., Bucheon-si (KR)

(72) Inventors: Yong-Sang SHIN, Bucheon-si (KR); In-Ki PARK, Seoul (KR); Hyun-Chul EUM, Seoul (KR)

(21) Appl. No.: 14/317,421

(22) Filed: Jun. 27, 2014

Related U.S. Application Data
(60) Provisional application No. 61/840,105, filed on Jun. 27, 2013.

(30) Foreign Application Priority Data
Jun. 9, 2014 (KR) 10-2014-0069240

(51) Int. Cl. H02M 1/36; H02M 3/335

(52) U.S. Cl. CPC H02M 1/36; H02M 3/33507
USPC 363/21.12

(57) ABSTRACT

A start-up circuit includes a first zener diode and a second zener diode coupled to each other, a first switch configured to perform a switching operation according to at least one of a first zener voltage of the first zener diode and a second zener voltage of the second zener diode, at least one second switch coupled to the first zener diode and the second zener diode, and a driving unit configured to drive the at least one second switch using a driving signal of a power switch which controls power supply.

### CROSS-REFERENCE TO RELATED APPLICATION

This application claims priority to and the benefit of U.S. Patent Application No. 61/840,105 filed in the USPTO on Jun. 27, 2013, and the priority and benefit of Korean Patent Application No. 10-2014-0069240 filed in the Korean Intellectual Property Office on Jun. 9, 2014, the entire contents of which are incorporated herein by reference.

### BACKGROUND

1. Field

Embodiments relate to a start-up circuit, a switch control circuit having the start-up circuit, and a power supply device having the switch control circuit.

2. Description of the Related Art

When a line input in which an alternating current (AC) input is rectified is small, there is a limit to which a start-up period in a start-up circuit using a start-up resistor can be shortened.

Further, when a short circuit is generated in output terminals, a rectification diode of a secondary side may be damaged. For example, after a protective operation is generated, in an automatic restart mode operating again after a predetermined time, the rectification diode of the secondary side may be overheated due to repetitive start-up operations.

In addition, there is a problem in which efficiency is reduced since a current always flows through the start-up resistor.

### SUMMARY

Embodiments provide a start-up circuit, a switch control circuit having the start-up circuit, and a power supply device having the switch control circuit.

According to one aspect of the invention, there is provided a start-up circuit including: a first zener diode and a second zener diode coupled to each other; a first switch configured to perform a switching operation according to at least one of a first zener voltage of the first zener diode and a second zener voltage of the second zener diode; at least one second switch coupled to the first zener diode and the second zener diode; and a driving unit configured to drive the at least one second switch using a driving signal of a power switch which controls power supply.

The at least one second switch may be coupled to a node to which the first zener diode and the second zener diode are serially coupled.

In one embodiment, a gate voltage of the first switch may be controlled according to the first zener voltage during a period in which the at least one second switch is turned on.

In another embodiment, a gate voltage of the first switch may be controlled according to a voltage obtained by adding the first zener voltage and the second zener voltage during a period in which the at least one second switch is turned off.

The driving unit may include a capacitor electrically coupled to the driving signal of the power switch, and the at least one second switch may perform a switching operation according to a voltage of the capacitor.

The first zener diode and the second zener diode may be coupled in parallel. The at least one second switch may include a third switch coupled to the first zener diode and a fourth switch coupled to the second zener diode.

A gate voltage of the first switch is controlled according to the first zener voltage during a period in which the third switch is turned on. Or, a gate voltage of the first switch is controlled according to the second zener voltage during a period in which the fourth switch is turned on.

According to another aspect of the invention, there is provided a switch control circuit for controlling a switching operation of a power switch which controls output power of a power supply device, including: a first switch coupled to an input voltage of the power supply device; a first voltage supply unit and a second voltage supply unit configured to control a gate voltage of the first switch; at least one second switch coupled to the first and second voltage supply units; and a driving unit configured to drive the at least one second switch using a driving signal of the power switch.

The first voltage supply unit and the second voltage supply unit may be a first zener diode and a second zener diode, respectively, and the at least one second switch may be coupled to a node to which the first zener diode and the second zener diode are serially coupled.

In one embodiment, a gate voltage of the first switch may be controlled according to a first zener voltage of the first zener diode during a period in which the at least one second switch is turned on.

In another embodiment, a gate voltage of the first switch may be controlled according to a voltage obtained by adding the first zener voltage of the first zener diode and the second zener voltage of the second zener diode during a period in which the at least one second switch is turned off.

The driving unit may include a capacitor electrically coupled to the driving signal of the power switch, and the at least one second switch may perform a switching operation according to a voltage of the capacitor.

The switch control circuit may further include a first capacitor configured to receive a voltage from an auxiliary winding in which a voltage corresponding to an output voltage of the power supply device is generated, and a third zener diode comprising a cathode coupled to the auxiliary winding and the first capacitor, and an anode coupled to a control electrode of the at least one second switch.

The driving unit may include a capacitor electrically coupled to the driving signal of the power switch, and the anode of the third zener diode is coupled to the capacitor.

The switch control circuit may further include a PWM controller configured to receive feedback information on the output voltage of the power supply device and control a switching operation of the power switch, wherein the driving signal of the power switch may be generated in the PWM controller.

According to still another aspect of the invention, there is provided a power supply device for transferring power of a primary side to a secondary side, including: a power switch coupled to an input voltage of the primary side; a first switch including one electrode coupled to the input voltage; a first capacitor coupled to the other electrode of the first switch and an auxiliary winding; a first voltage supply unit and a second voltage supply unit configured to control a gate voltage of the first switch; at least one second switch coupled to the first and second voltage supply units; and a driving unit configured to drive the at least one second switch using a driving signal of the power switch.

The first voltage supply unit and the second voltage supply unit may be a first zener diode and a second zener diode, respectively, and the at least one second switch may be coupled to a node to which the first zener diode and the second zener diode are serially coupled.

During a start-up period, the at least one second switch may be turned off, and a voltage of a control electrode of the first switch may be controlled according to a voltage obtained by adding a first zener voltage of the first zener diode and a second zener voltage of the second zener diode. After the start-up period, when the at least one second switch is turned on, the voltage of the control electrode of the first switch may be controlled by the first zener voltage of the power supply device.

When the secondary side of the power supply device is short-circuited, the driving signal of the power switch may not be generated, a voltage of a control electrode of the at least one second switch may decrease, the at least one second switch may be turned off, and a voltage of a control electrode of the first switch may be controlled according to a voltage obtained by adding a first zener voltage of the first zener diode and a second zener voltage of the second zener diode. A voltage of the first capacitor may be maintained at a UVLO level until a time at which the at least one second switch is turned off.

The power supply device may further include a third zener diode coupled between the auxiliary winding and a control electrode of the at least one second switch.

When the secondary side of the power supply device is open-circuited, the third zener diode may be turned on, a voltage of a control electrode of the at least one second switch may be maintained, the at least one second switch may be turned on, and the third zener diode may be cut off when a voltage of the first capacitor decreases to a VDD_ON level.

After the third zener diode is cut off, the driving signal of the power switch may not be generated, the voltage of the control electrode of the at least one second switch may decrease, the at least one second switch may be turned off, and a voltage of a control electrode of the first switch may be controlled according to a voltage obtained by adding a first zener voltage of the first zener diode and a second zener voltage of the second zener diode. A voltage of the first capacitor may be maintained at a UVLO level until a time at which the at least one second switch is turned off.

Embodiments may provide the start-up circuit, the switch control circuit having the start-up circuit, and the power supply device having the switch control circuit.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a diagram illustrating a power supply device according to one embodiment of the invention;

FIG. 2 is a waveform diagram for explaining a start-up operation according to an embodiment of the invention;

FIG. 3 is a waveform diagram for explaining a short circuit detection and protection operation according to an embodiment of the invention;

FIG. 4 is a waveform diagram for explaining a protection operation with respect to open circuit detection or an increase of an output voltage VOUT according to an embodiment of the invention; and

FIG. 5 is a diagram illustrating a power supply device according to another embodiment of the invention.

### DETAILED DESCRIPTION OF THE EMBODIMENTS

Example embodiments of the invention are described below in sufficient detail to enable those of ordinary skill in the art to embody and practice the invention. It is important to understand that the invention may be embodied in many alternate forms and should not be construed as limited to the example embodiments set forth herein. In accompanying drawings, in order to describe more clearly the embodiments of the invention, description of portions not related thereto will be omitted, and like reference numerals refer to like elements throughout.

Herein, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Further, it will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

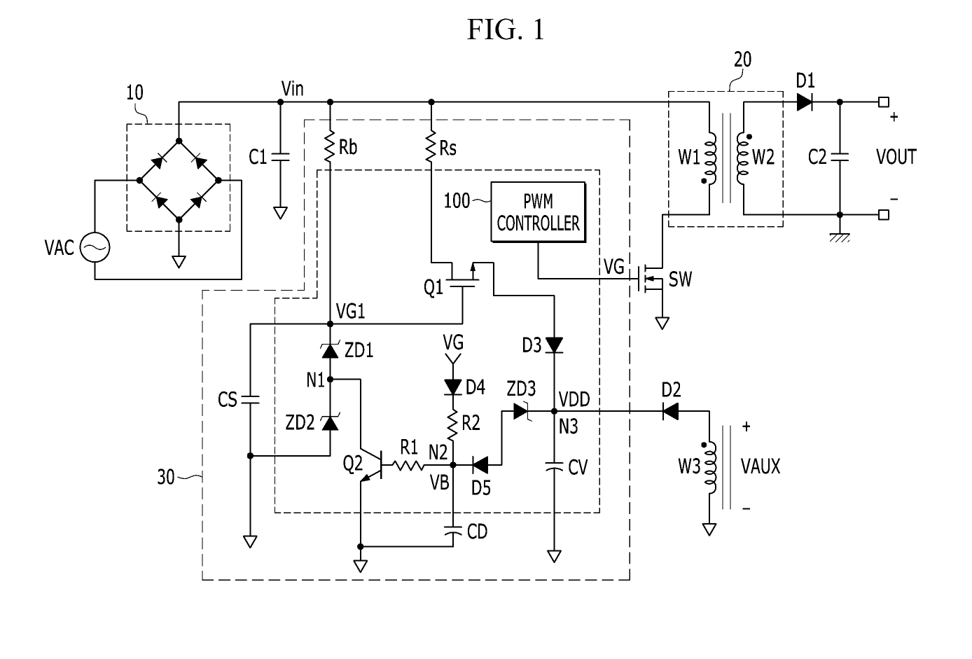

FIG. 1 is a diagram illustrating a power supply device according to one embodiment of the invention.

As shown in FIG. 1, a power supply device 1 may include a rectification circuit 10, a capacitor C1, a transformer 20, a rectification diode D1, an output capacitor C2, a power switch SW, a rectification diode D2, an auxiliary winding W3, and a switch control circuit 30.

The power supply device 1 shown in FIG. 1 may be implemented by a flyback converter, but embodiments thereof are not limited thereto.

Both output terminals of the power supply device 1 may be coupled to a load (not shown), and as an example of the load, there may be a plurality of light emitting diodes (LEDs) which are serially coupled.

An alternating current (AC) input may be rectified through the rectification circuit 10, and the rectified AC input may be filtered through the capacitor C1.

The rectification circuit 10 may be implemented by a full-bridge diode which is a full-wave rectification circuit shown in FIG. 1.

The transformer 20 may include a primary winding W1 coupled to an input voltage Vin and a secondary winding W2 coupled to an output voltage VOUT. The primary winding W1 and the secondary winding W2 may be insulated and coupled at a predetermined turn ratio (the number of turns of the primary winding n1:the number of turns of the secondary winding n2).

One end of the primary winding W1 may be coupled to the input voltage Vin, and the other end of the primary winding W1 may be coupled to one electrode (drain) of the power switch SW. Energy of an input current lin may be stored in the primary winding W1 during an on period of the power switch SW.

One end of the secondary winding W2 may be coupled to an anode of the rectification diode D1, and the other end of the secondary winding W2 may be coupled to a secondary ground. The energy stored in the primary winding W1 may be transferred to the secondary winding W2 during an off period of the power switch SW.

The power switch SW may be electrically coupled to the input voltage Vin, and control an output power of the power supply device. A gate of the power switch SW may be coupled to a gate voltage VG supplied from the switch control circuit 30, and the other electrode (source) of the power switch SW may be coupled to a primary ground. The power switch SW may be turned on in response to the gate voltage VG of a “high” level, and be turned off in response to the gate voltage VG of a “low” level.

The output capacitor C2 may be coupled between the output terminals of the power supply device 1. One electrode of the output capacitor C2 may be coupled to the cathode of the rectification diode D1, and the other electrode of the output capacitor C2 may be coupled to the secondary ground.

A current flowing through the secondary winding W2 may pass through the rectification diode D1. A current that has passed through the rectification diode D1 may be supplied to the load (not shown), and the output voltage VOUT may be smoothed by the output capacitor C2.

The auxiliary winding W3 may be located on the primary side of the power supply device 1 shown in FIG. 1, the primary winding W1 and the auxiliary winding W3 may be coupled at a predetermined turn ratio (n1:n3), and the secondary winding W2 and the auxiliary winding W3 may be insulated and coupled at a predetermined turn ratio (n2:n3).

During the on period of the power switch SW, a voltage between the ends of the primary winding W1 may be the input voltage Vin. Since a polarity of a voltage (hereinafter, an auxiliary voltage) VAUX between the ends of the auxiliary winding W3 may have an opposite polarity to a voltage between the ends of the primary winding W1, the auxiliary voltage VAUX may have a value obtained by multiplying a negative input voltage −Vin by the turn ratio (n1:n3) during the on period of the power switch SW. During an off period of the power switch SW, a voltage between the ends of the secondary winding W2 may be the output voltage VOUT, and the auxiliary voltage VAUX may have a value obtained by multiplying the output voltage VOUT by the turn ratio (n2:n3).

The switch control circuit 30 may generate the gate voltage VG based on feedback information on the output voltage VOUT back, control a start-up operation, and activate a protection operation in response to detecting a short circuit or an open circuit of output terminals of the secondary side.

The switch control circuit 30 may include a pulse width modulation (PWM) controller 100, and the PWM controller 100 may control a duty ratio according to the output voltage VOUT and generate the gate voltage VG.

For example, the PWM controller 100 may receive the information with respect to the output voltage VOUT of the secondary side as a feedback voltage through an opto-coupler, and control the gate voltage VG using an oscillator signal controlling a switching frequency of the power switch SW and the feedback voltage. The PWM controller 100 may be implemented in various manners, and a description thereof will be omitted.

The switch control circuit 30 may control the start-up operation, and control the start-up operation using two zener diodes ZD1 and ZD2, two switching elements Q1 and Q2, two resistors R1 and R2, and a capacitor CD.

A resistor Rb may be coupled between a cathode of the zener diode ZD1 and the input voltage Vin, and provide a bias current. A resistor Rs may be coupled between the input voltage Vin and a drain of the switch Q1, and perform a current limiting function for preventing overcurrent of the switch Q1 and other circuits.

The switch Q1 may be an element for switching in response to a first gate voltage VG1, and may be implemented by any one of transistors such as a metal oxide semiconductor field effect transistor (MOSFET), a junction field effect transistor (JFET), and the like.

In this embodiment, the switch Q1 may be implemented by an n-channel MOSFET, but embodiments thereof are not limited thereto.

The switch Q1 may include a drain coupled to the resistor Rs, a gate to which the first gate voltage VG1 is supplied, and a source coupled to an anode of the diode D3. The switch Q1 is not limited to the MOSFET.

A cathode of the diode D3 and one electrode of the capacitor CV may be coupled at a node N3, and the other electrode of the capacitor CV may be coupled to the primary ground. When the switch Q1 is turned on, the capacitor CV may be charged by a voltage supplied through the diode D3. When the switch Q1 is turned off, a voltage of the auxiliary winding W3 may be rectified through the diode D2, the rectified voltage may be supplied to the capacitor CV, and the capacitor CV may be charged. The voltage charged in the capacitor CV may be a power supply voltage VDD.

The zener diode ZD1 and the zener diode ZD2 may be serially coupled, and control the first gate voltage VG1 of the switch Q1. The zener diode ZD1 may perform a function of controlling the first gate voltage VG1 to an under-voltage lock out (UVLO) level, and the zener diode ZD2 with the zener diode ZD1 may perform a function of controlling the first gate voltage VG1 to a VDD_ON level.

That is, the zener diode ZD1 and the zener diode ZD2 may operate as a separate voltage supply unit for supplying the first gate voltage VG1 controlling the switching operation of the switch Q1.

The power supply voltage VDD may be a voltage needed for an operation of the switch control circuit 30, and when the power supply voltage VDD is smaller than a predetermined threshold value, the switch control circuit 30 may stop the operation. At this time, the predetermined threshold value may be the UVLO level. The VDD_ON level may mean a level that the power supply voltage VDD has to reach so that the switch control circuit 30 starts the operation. When the power supply voltage VDD reaches the VDD_ON level during the start-up period, the switch Q1 may be turned off, and the power supply voltage VDD may be controlled to have a voltage higher than the UVLO level by the auxiliary voltage VAUX.

Specifically, a zener voltage of the zener diode ZD1 may be a voltage that is a predetermined margin below the UVLO level, a voltage obtained by adding the zener voltage of the zener diode ZD1 and the zener voltage of the zener diode ZD2 may be set to be a voltage that is a predetermined margin above the VDD_ON level. The predetermined margins may be very small values, the zener voltage of the zener diode ZD1 may be substantially equal to the UVLO level, and the voltage obtained by adding the zener voltage of the zener diode ZD1 and the zener voltage of the zener diode ZD2 may be equal to the VDD_ON level.

A cathode of the zener diode ZD2 may be coupled to the anode of the zener diode ZD1, and an anode of the zener diode ZD2 may be coupled to the primary ground. A capacitor CS may be coupled between the cathode of the zener diode ZD1 and the primary ground, and filter and stabilize the first gate voltage VG1. The switch Q2 may be coupled to a node N1 to which the anode of the zener diode ZD1 and the cathode of the zener diode ZD2 are coupled.

When the switch Q2 is turned on, the node N1 may be coupled to the primary ground, and the first gate voltage VG1 may be controlled to have the UVLO level. When the switch Q2 is turned off, the node N1 may be coupled to the primary ground through the zener diode ZD2, and the first gate voltage VG1 may be controlled to have the VDD_ON level. In this embodiment, the switch Q2 may be implemented by the BJT, but the switch Q2 is not limited thereto and may be implemented by other types of transistors.

The switch Q2 may be coupled to the node N1 to bypass the zener diode ZD2, and control a level of the first gate voltage VG1. The switch Q2 may be switched according to a voltage of the node N2. For example, the switch Q2 may be implemented by any one of transistors such as the BJT (Bipolar Junction Transistor), the MOSFET, and the like. In this embodiment, the switch Q2 may be implemented by the BJT, but embodiments thereof are not limited thereto.

The switch Q2 may include a collector coupled to the node N1, a base coupled to the resistor R1, and an emitter coupled to the primary ground, and the base of the switch Q2 may receive a base voltage VB through the resistor R1. The resistor R1 may be coupled between the node N2 generating the base voltage VB and the base of the switch Q2.

The gate voltage VG may be input to an anode of a diode D4. For example, the gate voltage VG may be a PWM signal which is one of driving signals of the power switch SW. Embodiments are not limited thereto.

Instead of the gate voltage VG, a signal corresponding to the gate voltage VG among signals generated inside the PWM controller 100 may be used. Further, for example, a driving signal of the power switch SW may be a signal generated by detecting a start-up operation, but embodiments are not limited thereto. Instead of the driving signal of the power switch SW, another signal generated by the start-up operation, for example, an output voltage VOUT, a feedback voltage corresponding to the output voltage VOUT, or the like, may be used.

A cathode of the diode D4 may be coupled to one end of the resistor R2, and the other end of the resistor R2 may be coupled to the node N2. The capacitor CD may be coupled between the node N2 and the primary ground. The resistor R2 and the capacitor CD may generate the base voltage VB using the gate voltage VG transferred through the diode D4.

For example, a gate voltage VG2 may be generated as the base voltage VB by being low-pass filtered by the resistor R2 and the capacitor CD.

When a switching operation of the power switch SW is started, that is, when the gate voltage VG starts to be generated, the base voltage VB may start to increase. In a normal state, the base voltage VB may be constantly maintained by the capacitor CD after increasing to a predetermined level, the switch Q2 may be maintained in a turned-on state, and the first gate voltage VG1 may be controlled to have the UVLO level.

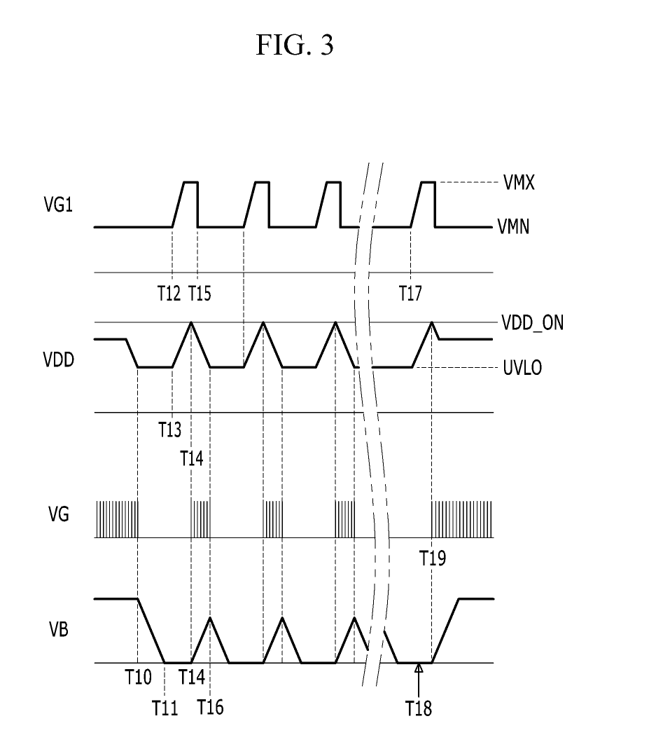

A start-up circuit according an embodiment of the invention may perform a protection operation upon detecting a short circuit. The operation will be described below with reference to FIG. 3.

The switch control circuit 30 may control an open circuit protection operation, and control the open circuit protection operation using a zener diode ZD3.

The zener diode ZD3 and a diode D5 may be serially coupled between a node N3 and the node N2. A cathode of the zener diode ZD3 may be coupled to the node N3, an anode of the zener diode ZD3 may be coupled to an anode of the diode D5, and the cathode of the diode D5 may be coupled to the node N2.

A zener voltage of the zener diode ZD3 may be set to be turned on when the power supply voltage VDD reaches an overvoltage reference voltage VDD_OVP. For example, a zener voltage of the zener diode ZD3 may be set to have a level greater than the VDD_ON level and smaller than the overvoltage reference voltage VDD_OVP.

The diode D5 may be coupled to block a voltage supplied from the node N2 to the node N3, but the diode D5 may not be coupled since a voltage of the node N3 may always be greater than that of the node N2.

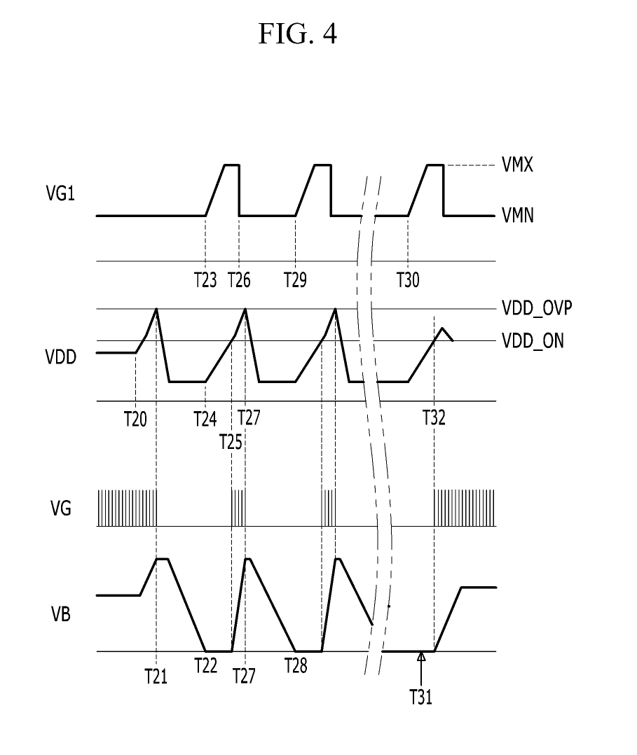

The open circuit protection operation using the zener diode ZD3 will be described below with reference to FIG. 4.

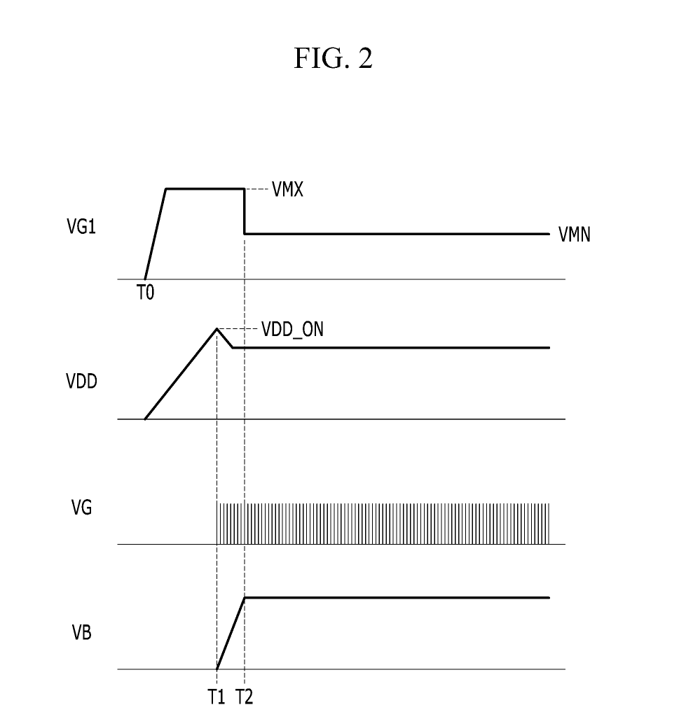

First, a start-up operation according to an embodiment of the present will be described with reference to FIG. 2.

FIG. 2 is a waveform diagram for explaining a start-up operation according to an embodiment of the invention.

In FIG. 2, waveforms of a first gate voltage VG1, a power supply voltage VDD, a gate voltage VG, and a base voltage VB are illustrated.

When the power is turned on at time T0, the capacitor CS may be charged by a voltage supplied through the resistor Rb. The gate voltage VG1 may start to increase from time T0, and the switch Q1 may be turned on according to the increase of the gate voltage VG1. The switch Q1 may be turned on, and the capacitor CV may be charged by a voltage supplied through the resistor Rs. Accordingly, the power supply voltage VDD may start to increase after the time T0.

The increased gate voltage VG1 may be maintained at a voltage VMX which is the voltage obtained by adding the zener voltage of the zener diode ZD1 and the zener voltage of the zener diode ZD2.

When the power supply voltage VDD that has increased from time T1 reaches the VDD_ON level, the PWM controller 100 may start to generate the gate voltage VG. After time T1, components (not shown) of the switch control circuit 30 including the PWM controller 100, etc. may start to operate, and the power supply voltage VDD may decrease.

The capacitor CD may be charged by the gate voltage VG, and the base voltage VB may start to increase. At time T2, the base voltage VB may increase to a level at which the switch Q2 can be turned on, and the switch Q2 may be turned on. Accordingly, the node N1 may be maintained at the zener voltage VMN of the zener diode ZD1.

The zener voltage VMN may be set to a value smaller than or very close to the UVLO level. When the power supply voltage VDD is greater than or equal to the UVLO level, since a source voltage of the switch Q1 is greater than the gate voltage VG1, the switch Q1 may be turned off. Accordingly, in a normal state after time T2, the switch Q1 may be turned off, and there is no power consumption through the resistor Rs. After the power supply voltage VDD reaches the VDD_ON level, the capacitor CV may be charged by a voltage generated in the auxiliary winding W3. The voltage of the auxiliary winding W3 may be rectified through the diode D2, and the rectified voltage may be supplied to the capacitor CV.

A protection operation of an embodiment when the output terminals are short-circuited or open-circuited after the start-up operation will be described.

FIG. 3 is a waveform diagram for explaining a short circuit detection and protection operation according to an embodiment of the invention.

When the output terminals are short-circuited, the output voltage VOUT may not be generated, and a voltage may not be generated in the auxiliary winding W3. Accordingly, the power supply voltage VDD may start to decrease. When the decreased power supply voltage VDD reaches the UVLO level at time T10, the PWM controller 100 may not generate the gate voltage VG.

When the power supply voltage VDD is smaller than the UVLO level, since the power supply voltage VDD is smaller than the gate voltage VG1 of the switch Q1, the switch Q1 may be turned on, and the capacitor CV may be charged. When the power supply voltage VDD is greater than the VDD_ON level, the switch Q1 may be turned off. The power supply voltage VDD may repeatedly increase and decrease between the VDD_On level and the UVLO level in response to the switching operation of the switch Q1. From time T10, since the gate voltage VG is not generated, the capacitor CD may be discharged, and the base voltage VB may start to decrease slowly. When the switch Q2 is turned off by the decreased base voltage VB, the gate voltage VG1 may be controlled to have the voltage VMX.

For example, as shown in FIG. 3, at time T11, the base voltage VB may have a level smaller than or equal to a threshold voltage level of the switch Q2, and from time T12, the gate voltage VG1 may start to increase. The increased gate voltage VG1 may be controlled to have a voltage VMX obtained by adding the zener voltages of two zener diodes ZD1 and ZD2. From time T13 when the switch Q1 is turned on by the increase of the gate voltage VG1, the capacitor CV may start to be charged, and the power supply voltage VDD may start to increase.

A period during which the power supply voltage VDD is maintained at the UVLO level may be controlled according to a degree to which the base voltage VB decreases due to the discharge of the capacitor CD. After the protection operation is started up, the power supply voltage VDD may increase according to the increase of the gate voltage VG1, and the switch Q2 should be turned off so that the gate voltage VG1 increases. A period from a time at which the gate voltage VG is not generated to a time at which the switch Q2 is turned off may be determined according to a discharging speed of the capacitor CD.

According to an embodiment, a period from a time at which a short circuit is generated to a time at which an automatic restart-up operation is started may be controlled by suitably controlling the capacitor CD as occasion requires.

When the power supply voltage VDD reaches the VDD_ON level at time T14, the switch control circuit 30 may be restarted, and the PWM controller 100 may start to generate the gate voltage VG.

Therefore, from time T14, the gate voltage VG may be low-pass filtered, and the base voltage VB may start to increase. At time T15, the switch Q2 may be turned on by the base voltage VB, and the gate voltage VG1 may be controlled to have the zener voltage VMN.

When the short circuit state is not resolved, the power supply voltage VDD may decrease to the UVLO level again. At time T16, when the power supply voltage VDD decreases to the UVLO level, the gate voltage VG may not be generated. Accordingly, after time T16, the base voltage VB may decrease again. The switch Q2 may be turned off again, and the gate voltage VG1 may increase and be controlled to have the voltage VMX.

The operation described above may be repeated during the short circuit state.

It is assumed that, at time T17, the gate voltage VG1 starts to increase, and at time T18, the short circuit state is resolved.

At time T19, the power supply voltage VDD may reach the VDD_ON level, the gate voltage VG may start to be generated, and the base voltage VB may start to increase. The power supply voltage VDD may not decrease to the UVLO level after the VDD_ON level, and may be maintained at a level of the normal state, and the base voltage VB may be maintained at a level at which the switch Q2 can be turned on.

Next, an open circuit detection and protection operation according to an embodiment will be described.

FIG. 4 is a waveform diagram for explaining a protection operation with respect to open circuit detection or an increase of an output voltage VOUT according to an embodiment of the invention.

When the output terminals are open-circuited or overvoltage occurs due to the output voltage VOUT, the auxiliary voltage VAUX may increase to the overvoltage according to the output voltage VOUT. When the auxiliary voltage VAUX increases to the overvoltage, the zener diode ZD3 may be turned on. A voltage is supplied to the capacitor CD through the zener diode ZD3, and a period during which the base voltage VB decreases may increase. Accordingly, a period during which the power supply voltage VDD is maintained at the UVLO level may increase.

For example, at time T20, the power supply voltage VDD may start to increase, and at time T21, the power supply voltage VDD may start to increase to the VDD_OVP level in which an overvoltage protection operation is started up. From time T21, the PWM controller 100 may not generate the gate voltage VG according to the protection operation. At time T21, the base voltage VB may be a voltage obtained by subtracting the zener voltage of the zener diode ZD3 from the VDD_OVP level, and the switch Q2 may be turned on.

Since the voltage is not generated in the auxiliary winding W3 by the start-up of the protection operation, the power supply voltage VDD may start to decrease from the time T21. When the power supply voltage VDD decreases to the VDD_ON level, the zener diode ZD3 may be cut off. During a period in which the zener diode ZD3 is turned on, the base voltage VB may be maintained at a predetermined level.

The decreased power supply voltage VDD may be maintained at the UVLO level by a voltage supplied through the switch Q1. After time T21, the decreased base voltage VB may have a level smaller than or equal to a threshold voltage of the switch Q2 at time T22.

The switch Q2 may be turned off by the decrease of the base voltage VB, and the gate voltage VG1 of the switch Q1 may start to increase from time T23 and be controlled to have the voltage VMX.

The switch Q1 may be turned on by the increase of the gate voltage VG1, the capacitor CV may start to be charged from time T24, and the power supply voltage VDD may start to increase. When the increased power supply voltage VDD reaches the VDD_ON level, the gate voltage VG may start to be generated. Accordingly, the base voltage VB may start to increase.

The switch Q2 may be turned on at time T26 by the increase of the base voltage VB, and the gate voltage VG1 may be controlled to have the zener voltage VMN.

At time T27, when the power supply voltage VDD reaches the VDD_OVP level, the overvoltage protection operation may be started up again, and the gate voltage VG may not be generated. At time T27, the base voltage VB may be obtained by subtracting the zener voltage of the zener diode ZD3 from the VDD_OVP level, and the switch Q2 may be turned on.

Since the voltage may not be generated in the auxiliary winding W3, the power supply voltage VDD may start to decrease from time T27. When the power supply voltage VDD decreases to the VDD_ON level, the zener diode ZD3 may be cut off. During a period in which the zener diode ZD3 is turned on, the base voltage VB may be maintained at a predetermined level.

The decreased power supply voltage VDD may be maintained at the UVLO level by a current supplied through the switch Q1. After time T27, the base voltage VB may be at a level smaller than or equal to the threshold voltage of the switch Q2 at time T28.

The operation described above is repeatedly performed during the open circuit state.

It is assumed that, at time T30, the gate voltage VG1 starts to increase, and at time T31, the open circuit state is resolved.

At time T32, the power supply voltage VDD may reach the VDD_ON level, the gate voltage VG may start to be generated, and the base voltage VB may start to increase. After the power supply voltage VDD reaches the VDD_ON level, the power supply voltage VDD may not decrease to the UVLO level and may be maintained at the level of the normal state, and the base voltage VB may be maintained at a level at which the switch Q2 can be turned on.

According to this embodiment, after the open circuit or the short circuit of the output terminals is detected, an automatic restart time may be controlled by the capacitor CD. The automatic restart time may be further delayed, when the base voltage VB decrease by a capacitance of the capacitor CD is on a gentler slope. Therefore, a switching period of the power switch SW during which energy is transferred to the secondary side may decrease, and heat generated in the secondary side may be reduced. During a period in which the switching operation is not generated, a discharge may be generated in the secondary side, and the heat generated in a diode of the secondary side may be reduced.

Instead of a high voltage switch, power consumption generated in the start-up resistor (in the embodiment, Rs) may be reduced by implementing the start-up circuit using the switching device.

In the embodiment described above, the gate of the switch Q1 and the base of the switch Q2 may be control electrodes, and the gate voltage VG and the base voltage VB may be voltages of the control electrodes.

In the embodiment described above, an example in which two zener diodes are serially coupled is described, but embodiments are not limited thereto. The couplion of two zener diodes may be modified.

For example, when the zener voltage of one of two zener diodes is a UVLO level and the zener voltage of the other is the VDD_ON level, the two zener diodes may be coupled to the first gate voltage VG1 in parallel.

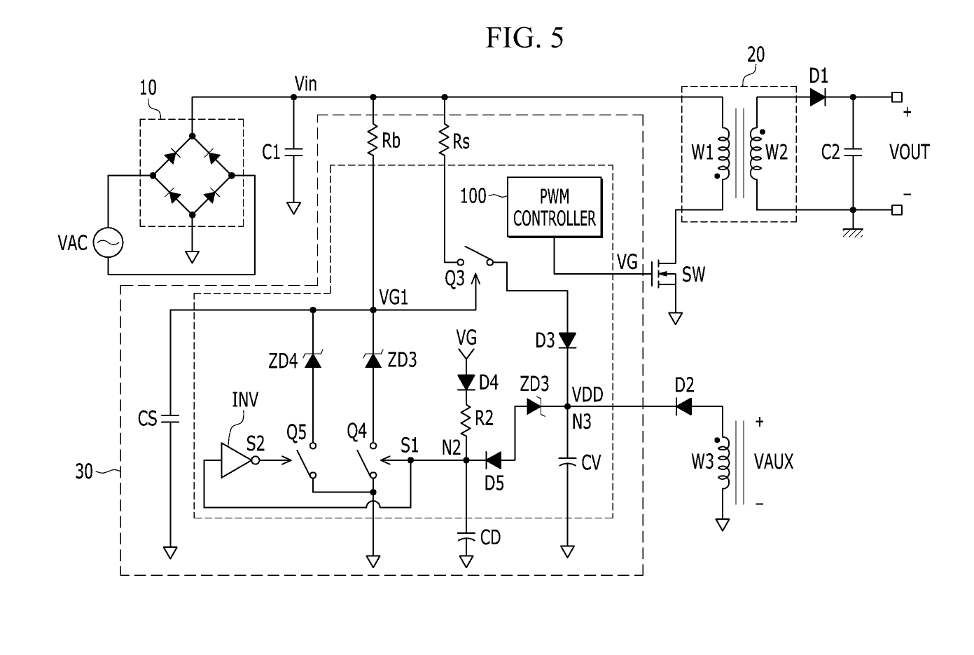

FIG. 5 is a diagram illustrating a power supply device according to another embodiment of the invention.

Like reference numerals are used for like elements of the embodiment described above, and a description thereof will be omitted.

The switch Q3 may perform a switching operation by the first gate voltage VG1. For example, the switch Q3 may be a JFET. Since the switching operation of the switch Q3 according to the first gate voltage VG1 may be the same as that of the switch Q1, a description thereof will be omitted.

A zener voltage of a zener diode ZD3 may be at the UVLO level, and may include an anode coupled to one end of a switch Q4 and a cathode coupled to the first gate voltage VG1. A zener voltage of a zener diode ZD4 may be the VDD_ON level, and include an anode coupled to one end of a switch Q5, and a cathode coupled to the first gate voltage VG1.

The other end of the switch Q4 and the other end of the switch Q5 may be coupled to a ground. The switch Q4 may be switched by a voltage S1 of the node N2, and the switch Q5 may be switched by a voltage S2. An inverter INV may invert the voltage S1 and generate the voltage S2.

When the switch Q4 is turned on by the voltage S1 of a “high” level, and the switch Q5 is turned off by the voltage S2 of a “low” level, the first gate voltage VG1 may be controlled to have the UVLO level.

When the switch Q4 is turned off by the voltage S1 of a “low” level and the switch Q5 is turned on by the voltage S2 of a “high” level, the first gate voltage VG1 may be controlled to have the VDD_ON level.

In FIGS. 1 to 5, components included in an area indicated by a dotted line inside the switch control circuit 30 may be designed as an integrated circuit (IC), the IC may include a plurality of pins, and one of the plurality of pins may be coupled to the capacitor CD. That is, since the capacitor CD may be formed outside the IC, it may be easily modified as needed.

Although a few embodiments of the invention have been shown and described, it would be appreciated by those skilled in the art that changes may be made in these embodiments without departing from the principles and spirit of the invention, the scope of which is defined in, but not limited to, the claims and their equivalents.

### DESCRIPTION OF SYMBOLS

1: power supply device
10: rectification circuit
C1: capacitor
20: transformer
D1: rectification diode
C2: output capacitor
SW: power switch
30: switch control circuit

What is claimed is:

1. A start-up circuit comprising:
a first zener diode;
a second zener diode coupled to the first zener diode;
a first switch configured to perform a switching operation according to at least one of a first zener voltage of the first zener diode and a second zener voltage of the second zener diode;
at least one second switch coupled to the first zener diode and the second zener diode; and
a driving unit configured to drive the at least one second switch using a driving signal of a power switch which controls power supply.

2. The start-up circuit according to claim 1, wherein the at least one second switch is coupled to a node to which the first zener diode and the second zener diode are serially coupled.

3. The start-up circuit according to claim 2, wherein a gate voltage of the first switch is controlled according to the first zener voltage during a period in which the at least one second switch is turned on.

4. The start-up circuit according to claim 2, wherein a gate voltage of the first switch is controlled according to a voltage obtained by adding the first zener voltage and the second zener voltage during a period in which the at least one second switch is turned off.

5. The start-up circuit according to claim 1, wherein the driving unit comprises a capacitor electrically coupled to the driving signal of the power switch; and
the at least one second switch performs a switching operation according to a voltage of the capacitor.

6. The start-up circuit according to claim 1, wherein the first zener diode and the second zener diode are coupled in parallel; and
the at least one second switch comprises a third switch coupled to the first zener diode and a fourth switch coupled to the second zener diode.

7. The start-up circuit according to claim 6, wherein a gate voltage of the first switch is controlled according to the first zener voltage during a period in which the third switch is turned on.

8. The start-up circuit according to claim 6, wherein a gate voltage of the first switch is controlled according to the second zener voltage during a period in which the fourth switch is turned on.

9. A switch control circuit for controlling a switching operation of a power switch which controls output power of a power supply device, comprising:
a first switch coupled to an input voltage of the power supply device;
a first voltage supply unit and a second voltage supply unit configured to control a gate voltage of the first switch;
at least one second switch coupled to the first and second voltage supply units; and
a driving unit configured to drive the at least one second switch using a driving signal of the power switch.

10. The switch control circuit according to claim 9, wherein the first voltage supply unit and the second voltage supply unit are a first zener diode and a second zener diode, respectively; and
the at least one second switch is coupled to a node to which the first zener diode and the second zener diode are serially coupled.

11. The switch control circuit according to claim 10, wherein a gate voltage of the first switch is controlled according to a first zener voltage of the first zener diode during a period in which the at least one second switch is turned on.

12. The switch control circuit according to claim 10, wherein a gate voltage of the first switch is controlled according to a voltage obtained by adding the first zener voltage of the first zener diode and the second zener voltage of the second zener diode during a period in which the at least one second switch is turned off.

13. The switch control circuit according to claim 9, wherein the driving unit comprises a capacitor electrically coupled to the driving signal of the power switch; and
the at least one second switch performs a switching operation according to a voltage of the capacitor.

14. The switch control circuit according to claim 9, further comprising:
a first capacitor configured to receive a voltage from an auxiliary winding in which a voltage corresponding to an output voltage of the power supply device is generated; and
a third zener diode comprising a cathode coupled to the auxiliary winding and the first capacitor and an anode coupled to a control electrode of the at least one second switch.

15. The switch control circuit according to claim 14, wherein the driving unit comprises a capacitor electrically coupled to the driving signal of the power switch; and
the anode of the third zener diode is coupled to the capacitor.

16. The switch control circuit according to claim 9, further comprising:
a PWM controller configured to receive feedback information on the output voltage of the power supply device and control a switching operation of the power switch, wherein the driving signal of the power switch is generated in the PWM controller.

17. A power supply device comprising:
a power switch coupled to an input voltage;
a first switch including an electrode coupled to the input voltage;
a first capacitor coupled to another electrode of the first switch and an auxiliary winding;
a first voltage supply unit and a second voltage supply unit configured to control a gate voltage of the first switch;
at least one second switch coupled to the first and second voltage supply units; and
a driving unit configured to drive the at least one second switch using a driving signal of the power switch.

18. The power supply device according to claim 17, wherein the first voltage supply unit and the second voltage supply unit are a first zener diode and a second zener diode, respectively; and
the at least one second switch is coupled to a node to which the first zener diode and the second zener diode are serially coupled.

19. The power supply device according to claim 18, wherein, during a start-up period, the at least one second switch is turned off and a voltage of a control electrode of the first switch is controlled according to a voltage obtained by adding a first zener voltage of the first zener diode and a second zener voltage of the second zener diode; and
after the start-up period, the at least one second switch is turned on and the voltage of the control electrode of the first switch is controlled according to the first zener voltage.

20. The power supply device according to claim 18, wherein, when the power supply device is short-circuited, the driving signal of the power switch is not generated, a voltage of a control electrode of the at least one second switch decreases, the at least one second switch is turned off, and a voltage of a control electrode of the first switch is controlled according to a voltage obtained by adding a first zener voltage of the first zener diode and a second zener voltage of the second zener diode, and a voltage of the first capacitor is maintained at an under voltage lock out level when the at least one second switch is turned on.

21. The power supply device according to claim 18, further comprising a third zener diode coupled between the auxiliary winding and a control electrode of the at least one second switch.

22. The power supply device according to claim 21, wherein, when the power supply device is open-circuited, the third zener diode is turned on, a voltage of a control electrode of the at least one second switch is maintained, the at least one second switch is turned on, and the third zener diode is cut off when a voltage of the first capacitor decreases to a VDD_ON level.

23. The power supply device according to claim 22, wherein, after the third zener diode is cut off, the driving signal of the power switch is not generated, the voltage of the control electrode of the at least one second switch decreases, the at least one second switch is turned off, a voltage of a control electrode of the first switch is controlled according to a voltage obtained by adding a first zener voltage of the first zener diode and a second zener voltage of the second zener diode, and a voltage of the first capacitor is maintained at an under voltage lock out level until a time at which the at least one second switch is turned off.
